(19) United States
(12) Patent Application Publication
(10) Pub. No.: US 2009/0199125 A1
(43) Pub. Date: Aug. 6, 2009

(54) MEDICAL SUPPORT CONTROL SYSTEM

(76) Inventors: Kiyoshi SEKIGUCHI, Tokyo (JP); Masaru ITO, Yokohama (JP); Koichi TASHIRO, Sagamihara (JP); Nobuyuki FURUKAWA, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/026,068

(22) Filed: Feb. 5, 2008

(51) Int. Cl. G06F 3/048

(52) U.S. Cl. 715/778

(57) ABSTRACT

A medical support control system, comprising: a first controller connected to at least one device; a second controller connected to at least one device; and a manipulation display device shared by the first and second controllers, wherein: the manipulation display device is caused to alternately display a first graphical user interface created by the first controller and a second graphical user interface created by the second controller.

### BACKGROUND OF THE INVENTION

1. Field of the Invention

The present invention relates to a medical support control system for controlling medical devices and non-medical devices used for operations.

2. Description of the Related Art

Operating systems using medical controllers or the like for controlling medical devices such as endoscopes or the like used for operations have been proposed. Medical devices to be controlled such as electric knives, insufflation devices, endoscope cameras, light source devices, or the like are connected to the medical controller (also referred to as MC). Also, a display device, a manipulation panel, or the like is connected to the MC. The manipulation panel includes a display unit and a touch sensor, and is used as a central manipulation device by nurses or the like working in an unsterilized area. The display device is used for displaying endoscope images or the like.

There is audio-visual equipment in the operating room such as a room light, a room camera, an interphone device, a liquid crystal display device, or the like (non-medical devices). The audio-visual equipment is controlled independently or by a non-medical controller (also referred to as an NMC) used for the central control.

Japanese Patent Application Publication No. 2006-000536, for example, discloses an operating system, comprising:

a first controller connected to a medical device provided in an operating room;

a second controller connected to a non-medical device provided in the operating room; and

manipulation instruction input means transmitting the content of a manipulation instruction for the medical device or the non-medical device to the first controller when a manipulation instruction is input. The first controller transmits to the second controller a first control signal in accordance with the manipulation instruction of the non-medical device input into the manipulation instruction means. The second controller converts the first control signal into a second control signal used for controlling the non-medical device, and transmits the second control signal to the non-medical device. Thereby, the operating system and a non-medical system work together, and the operating person himself/herself or the like can manipulate the non-medical devices.

### SUMMARY OF THE INVENTION

One aspect of the present invention is a medical support control system, comprising:

a first controller connected to at least one device;

a second controller connected to at least one device; and

a manipulation display device shared by the first and second controllers, wherein:

the manipulation display device is caused to alternately display a first graphical user interface created by the first controller and a second graphical user interface created by the second controller.

The first controller has first identification information and user environment information corresponding to the first identification information;

the second controller has second identification information and user environment information corresponding to the second identification information; and

when log-in to at least one of the first and second controllers has succeeded, an operation environment for the controller to which the log-in has succeeded is set in accordance with the user environment information.

An operation environment is set for controllers other than the controller to which the log-in has succeeded, in accordance with user environment information common to all users.

The identification information includes at least an operating person name and a procedure name; and

the user environment information is operation environment information of the controller to which the log-in has succeeded, used for setting an operation environment appropriate for a procedure performed by an operating person identified by the operating person name and the procedure name.

### BRIEF DESCRIPTION OF THE DRAWINGS

FIG. 1 shows an entire configuration of a medical device control system according to the present embodiment;

FIG. 2 is a block diagram showing an entire configuration of a medical support system 100 according to the present embodiment;

FIG. 3 is a block diagram showing an NMC 202 in the present embodiment;

FIG. 4 shows switching of a control target by a TP control switching unit 305 performed between the NMC 202 and an MC 114;

FIG. 5 shows examples of windows displayed on a TP 221 in the present embodiment;

FIG. 6 shows a flowchart for log-in and windows displayed on the TP 221 in the present embodiment;

FIG. 7 is a flowchart for setting an operation environment in the present embodiment; and

FIG. 8 shows the data structure of an MC-side database and an NMC side database in the present embodiment.

### DESCRIPTION OF THE PREFERRED EMBODIMENTS

Hereinafter, the embodiments of the present invention will be explained in detail, referring to the drawings.

A medical support control system according to the present embodiment includes a medical device control system and a non-medical device control system. The medical device control system includes a plurality of medical devices and a medical controller for controlling these medical devices. The non-medical device control system includes non-medical devices (that may further include medical devices) that are used for operations, and a non-medical controller for controlling these non-medical devices.

An endoscopic operating system will be explained as an example of the medical device control system.

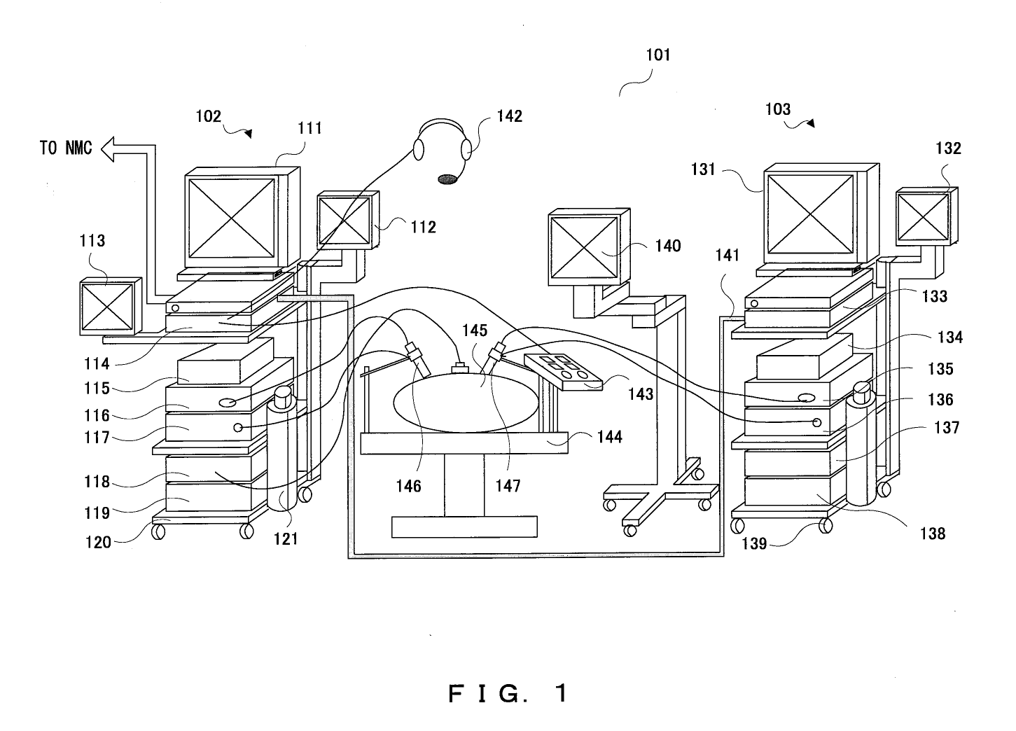

FIG. 1 shows an entire configuration of the medical device control system according to the present embodiment. An endoscopic operating system is shown as a medical device control system 101. In the operating room, a first endoscopic operating system 102 and a second endoscopic operating system 103 beside a bed 144 on which a patient 145 is laid and a wireless remote controller 143 for the operating person are provided.

The endoscopic operating systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a medical controller (MC) 114, a recorder 115, a video processor 116, an endoscope light source device 117, an insufflation unit 118, and an electrical surgical device 119 are arranged.

The central manipulation panel device 113 is arranged in an unsterilized area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the MC 114 via communication cables (not shown) such as serial interface cables or the like, and can have communications with one another.

Also, a headset-type microphone 142 can be connected to the MC 114. The MC 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The insufflation unit 118 provides CO₂ gas to the abdomen of the patient 145 through a tube. The CO₂ gas is obtained from a gas tank 121.

On the second trolley 139, an endoscope image display panel 131, a central display panel 132, a expansion unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the expansion unit 133 through cables (not shown), and can communicate with one another. The MC 114 and the expansion unit 133 are connected to each other through the expansion cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131.

Further, the MC 114 can be controlled by the operating person manipulating the devices in the unsterilized area. Also, the first and second trolleys 120 and 139 can include other devices such as printers, ultrasonic observation devices, or the like.

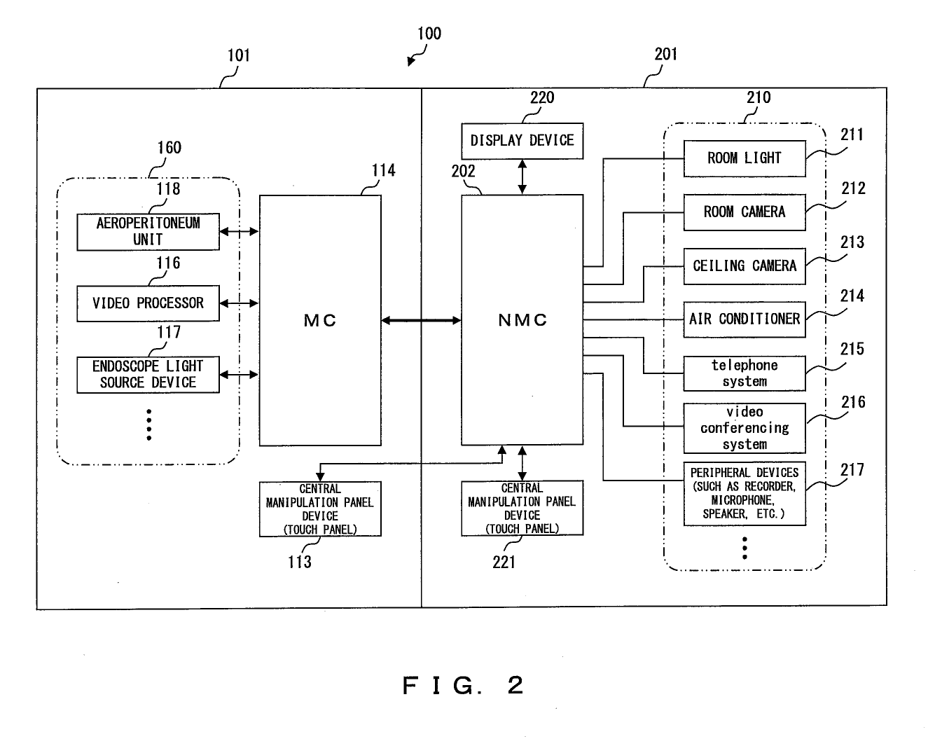

FIG. 2 is a block diagram showing an entire configuration of a medical support control system 100 according to the present embodiment. As described above, the medical support control system 100 includes the medical device control system 101 and a non-medical device control system 201. A detailed configuration of the medical device control system 101 is as shown in FIG. 1. However, in FIG. 2, the medical device control system 101 is shown in a simplified manner for simplicity of explanation.

In FIG. 2, a medical device group 160 is a group of medical devices that are directly connected to the medical controller 114 or are indirectly connected to the MC 114 via the expansion unit 133. Examples of the devices included in the medical device group 160 are the insufflation unit 118, the video processor 116, the endoscope light source device 117, the electrical surgical device 119, and the like.

The central manipulation panel device 113 has a touch panel, and in accordance with the information input into the touch panel, the devices connected to the MC 114 or a non-medical device controller (NMC) 202 that will be described later can be manipulated.

The non-medical control system 201 includes the NMC 202 connected to the MC 114 through a communication cable or the like, and a non-medical device group 210. In this configuration, the NMC 202 can transmit and receive, through an image cable, the video signals to and from the medical device group 160 connected to the MC 114.

The NMC 202 controls the non-medical devices (including the audio-visual devices) connected thereto. As shown in FIG. 2, the non-medical device group 210 connected to the NMC 202 according to the present embodiment consists of a room light 211, a room camera 212, a ceiling camera 213, an air conditioner 214, a telephone system 215, a conference system 216 to be used for individuals in remote places (referred to as a video conference system hereinafter), and other peripheral devices 217. Further, a display device 220 and a central manipulation panel device 221 are connected to the NMC 202.

Also, the non-medical device group 210 includes equipment such as light devices provided in the operating room in addition to the AV devices used for recording and reproducing image data.

The display device 220 is a plasma display panel (PDP) or a liquid crystal display (LCD) device, and displays images of the predetermined device or images of the devices selected by nurses or the like through the central manipulation panel device 221. The room light 211 is a device that illuminates the operating room. The room camera 212 is used for shooting images of the situations in the operating room. The ceiling camera 213 is a camera suspended from the ceiling whose positions can be changed. The conference system 216 is a system that displays images and transmits voices of nurses or the like in the medical office or the nurse stations, and enables conversations with them. The peripheral devices 217 are, for example, a printer, a CD player, a DVD recorder, and the like. The central manipulation panel device 221 has a touch panel that is the same as that included in the central manipulation panel device 113, and controls the respective AV devices connected to the NMC 202. The central manipulation panel devices 113 and 221 are referred to as TPs hereinafter.

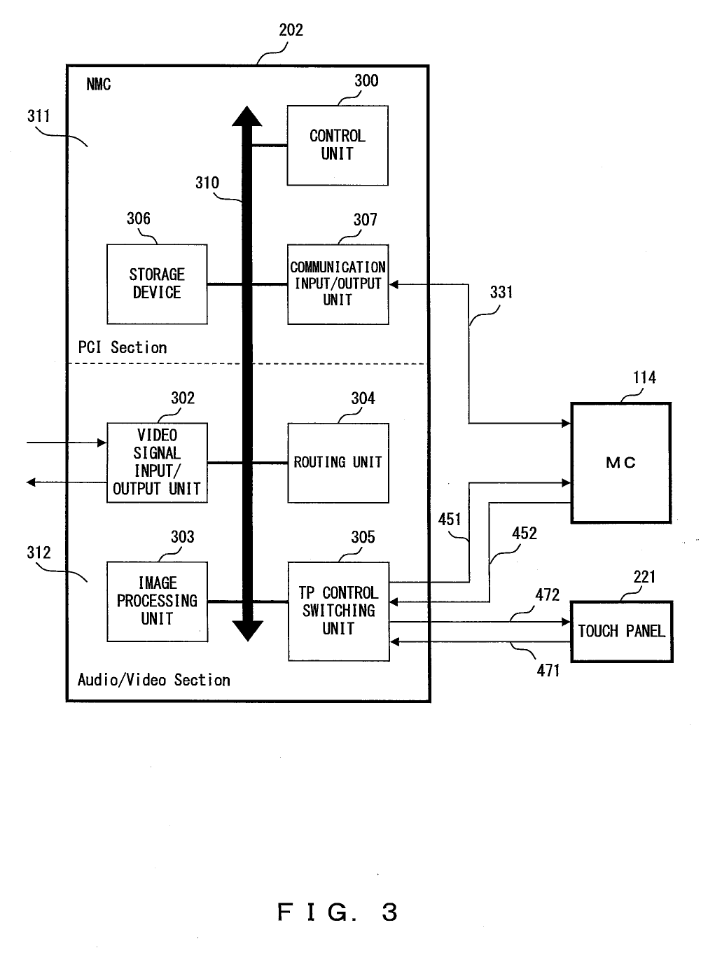

FIG. 3 is a block diagram showing a configuration of the NMC 202 in the present embodiment. The NMC 202 includes a PCI section 311 and an audio/video (A/V) section 312.

The PCI section 311 mainly controls a non-medical device group 210 connected to the NMC 202. The PCI section 311 includes a control unit 300, a storage device 306, and a communication input/output unit 307. Numerical symbol 310 denotes a back plane.

The control unit 300 controls the entirety of the PCI section 311, and transmits and receives data to and from the A/V section 312. The control unit 300 creates Graphical User Interface image information (hereinafter referred to as GUI image information) that is an image layout to be displayed on a TP 221 or a monitor device, and transmits it to a routing unit 304. Also, as will be described later, the control unit 300 performs processes for the transmission and reception of data based on communications with the MC 114 via a communication line 331. The NMC 202 and the MC 114 monitor each other via the communication line 331, and synchronize each other's GUI environment.

The storage device 306 stores various programs, information set by the TP 221, and the like. The communication input/output unit 307 is a communication interface used for the communications with the MC 114 via the communication line 331.

The A/V section 312 is a section that mainly processes the video signals and the audio signals. The A/V section 312 includes a video signal input/output unit 302, an image processing unit 303, a routing unit 304, and a TP control switching unit 305.

The video signal input/output unit 302 has a plurality of video signal input ports and a plurality of video signal output ports.

The routing unit 304 switches routes for the video signals that were processed in the image processing unit 303 and the video signals input from the video signal input/output unit 302, and transfers them to a prescribed configuration unit in the NMC 202. Also, the routing unit 304 transfers to the TP control switching unit 305 the GUI image information created in the control unit 300.

The image processing unit 303 performs image processing on the image information transferred from the routing unit 304. Examples of the image processing are enlargement/reduction (scaling) of images, mirroring of images, rotation of images, displaying another, smaller image in a main image (picture in picture (PIP)), and displaying a plurality of images simultaneously (picture out picture (POP)).

TP coordinate communication lines 451 and 471 are communication lines through which TP coordinate signals generated by touch manipulations on the TP 221 are conveyed. TP image lines 452 and 472 are image lines through which image signals such as GUI images or the like to be displayed on the TP 221 are conveyed.

The TP control switching unit 305 synthesizes the GUI image created in the control unit 300 with images created on the basis of the video signals transmitted from the video signal input/output unit 302. Then, the TP control switching unit 305 outputs the synthesized image to the TP 221. Further, the TP control switching unit 305 can perform switching between the NMC 202 and the MC 114 as the manipulation targets of the TP 221. In other words, the TP control switching unit 305 receives TP coordinate information based on the touch manipulation on the TP 221 from the TP 221, transfers the received TP coordinate information to the control unit 300, or transfers the TP coordinate information to the MC 114.

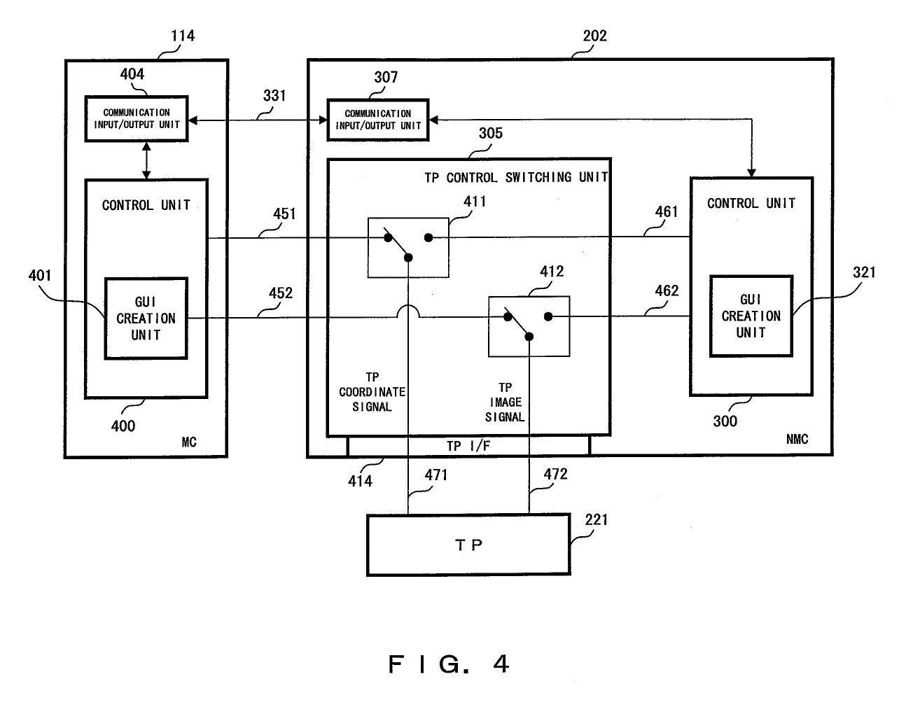

FIG. 4 shows the switching of the control targets between the NMC 202 and the MC 114 by using the TP control switching unit 305 according to the present embodiment.

As described above, the MC 114 (first controller) is a controller mainly for medical devices. The MC 114 creates a graphical user interface (first GUI) that is a window used for controlling the medical devices.

As described above, NMC 202 (second controller) is a controller mainly form on-medical devices. The NMC 202 creates another graphical user interface (second GUI) as a window used for controlling the non-medical devices.

The first and second GUIs are designed on the basis of a common graphical user interface (common GUI). For example, by switching the tabs on a window on the TP 221, the first and second GUIs can be switched therebetween.

The control unit 300 has a GUI creation unit 321. The GUI creation unit 321 creates the second GUI.

The control unit 400 has a GUI creation unit 401. The GUI creation unit 401 creates the first GUI.

TP coordinate communication lines 451, 461, and 471 are communication lines through which TP coordinate signals of the TP 221 are transmitted to the control unit 400 of the MC 114 or to the control unit 300 of the NMC 202.

TP image lines 452, 462, and 472 are image lines through which video signals of the first GUI image, the second GUI image, or the like to be displayed on the TP 221 are transmitted from the control unit 400 of the MC 114 to the TP 221 or from the control unit 300 of the NMC 202 to the TP 221.

The TP control switching unit 305 has a TP coordinate communication line switch 411, a TP image line switch 412, and a TP interface 414 (TP I/F).

The TP interface 414 is an interface to which the TP image line and the TP coordinate communication line for connecting the TP 221 and the NMC 202 are connected.

The TP coordinate communication line switch 411 is a switch device used for connecting the TP coordinate communication line 471 to the TP coordinate communication line 451 on the MC 114 side or to the TP coordinate communication line 461 on the NMC 202 side.

The TP image line switch 412 is a switch device used for connecting the TP image line 472 to the TP image line 452 on the MC 114 side or to the TP image line 462 on the NMC 202 side.

Explanation will be given for a case in which the TP coordinate communication line 451 is selected by the TP coordinate communication line switch 411 and the TP image line 452 is selected by the TP image line switch 412.

Data of the first GUI generated in the GUI creation unit 401 (TP image signal) is input into the TP 221 via the TP image line switch 412, and the first GUI is displayed on the TP 221. In this case, a TP coordinate signal 481 generated by touch manipulations on the first GUI displayed on the TP 221 is input into the control unit 400 from the TP 221 via the TP coordinate communication line switch 411.

Explanations will be given for a case in which the TP coordinate communication line 461 is selected by the TP coordinate communication line switch 411 and the TP image line 462 is selected by the TP image line switch 412. Data of the second GUI generated in the GUI creation unit 401 (TP image signal) is input into the TP 221 via the TP image line switch 412, and the second GUI is displayed on the TP 221. The TP coordinate signal 481 generated by the touch manipulations on the second GUI displayed on the TP 221 is input into the control unit 300 from the TP 221 via the TP coordinate communication line switch 411.

Next, explanations will be given for a case in which the first GUI transitions to the second GUI in response to the touch manipulations on the TP 221. The TP coordinate signal generated by the touch manipulation on the TP 221 is transmitted to the control unit 400 of the MC 114. The control unit 400, having received this TP coordinate signal, reports via the a communication input/output unit 404 and the communication line 331 to the control unit 300 of the NMC 202 the fact that the first GUI will be switched to the second GUI. The control unit 300, having received this report, controls the TP control switching unit 305 and switches the TP coordinate communication line switch 411 and the TP image line switch 412 so that the TP coordinate communication line 461 and the TP image line 462 on the NMC 202 side are enabled. Then, the control unit 300 causes the TP 221 to display the second GUI via the TP image lines 462 and 472. Additionally, this process is also applied to the case in which the second GUI transitions to the first GUI in response to the touch manipulations.

The control unit 300 and the control unit 400 communicate with and monitor each other via the communication line 331. Also, the control unit 300 and the control unit 400 synchronize each other's GUI environment, and exchange information that has to be held by both of them for configuring a common GUI. An example of the above information are window elements (window element information such as tab names) to be used in common.

As described above, the target to be controlled by the TP 221 is changed between the MC 114 and the NMC 202 on the basis of the switching operations of the TP control switching unit 305. This switching operation is not perceived by users, and accordingly users feel as if they are controlling only one controller.

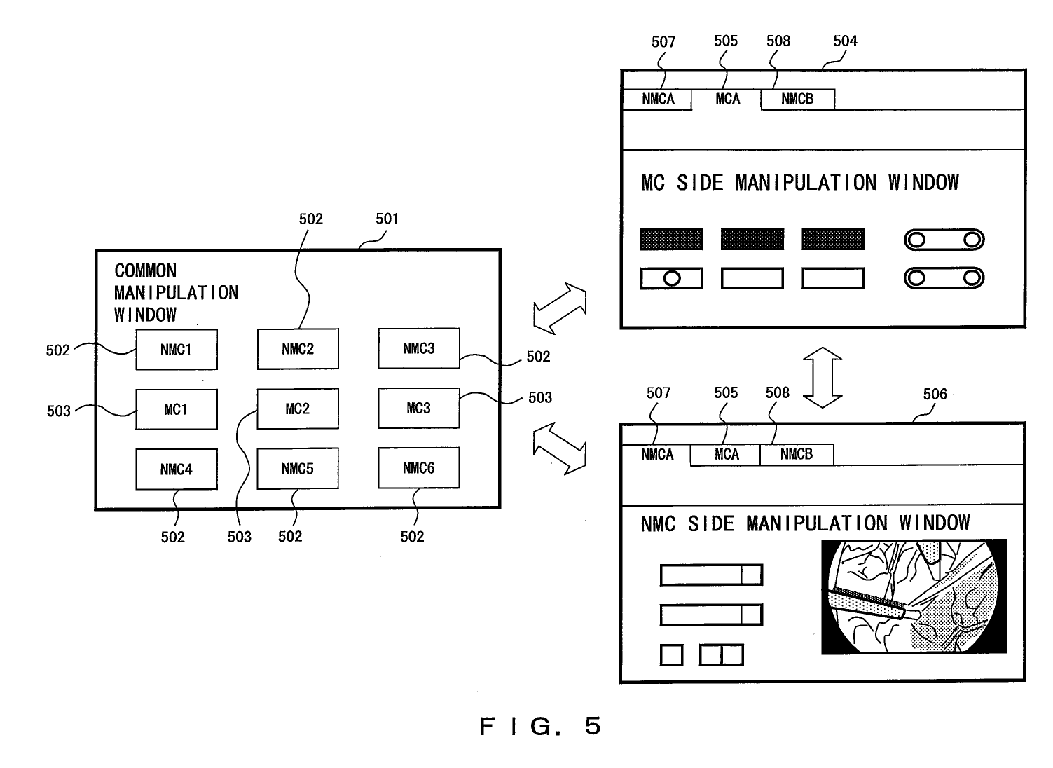

FIG. 5 shows transitions of the GUIs displayed on the TP 221. A main GUI 501 shown in FIG. 5 is a common manipulation window used for selecting the first or second GUI. By performing touch manipulations on the TP 221, the first or second GUI created in the MC 114 and the NMC 202 is selected. For example, when functions on the NMC 202 side are to be used, NMC selection switch buttons 502 (NMC 1 through NMC 6) are used, and when functions on the MC 114 side are to be used, MC selection switch buttons 505 (MC 1 through MC 3) are used. The main GUI 501 may be created on the MC 114 side, and also may be created on the NMC 202 side.

When one of the MC selection switch buttons on the main GUI 501 is selected, the first GUI (manipulation window on the MC side) is opened, and an MC-side manipulation window 504 and the like is displayed. An example of the MC-side manipulation window 504 is a window used for setting parameters or the like for medical devices. On the MC-side manipulation window 504, an NMC transition switch button 507 (NMCA) for opening an NMC-side manipulation window 506 and an NMC transition switch button 508 (NMCB) are displayed.

Also, when one of the NMC selection switch buttons 502 on the main GUI 501 is selected, the second GUI (manipulation window on the NMC side) is opened, and an NMC-side manipulation window 506 or the like is displayed. An example of the NMC-side manipulation window 506 is a window used for setting parameters or the like for non-medical devices. On the NMC-side manipulation window 506, an MC transition switch button 505 (MCA) used for opening the MC-side manipulation window 504 is displayed.

Also, when it is desired that the MC-side manipulation window 504 transits to the NMC-side manipulation window 506, the NMC transition switch button 507 is selected.

Also, when it is desired that the NMC-side manipulation window 506 transits to the MC-side manipulation window 504, the MC selection switch button 505 is selected.

Also, in the first and second GUIs that are not shown in FIG. 5, by selecting transition switch buttons corresponding to the NMC transition switch buttons 507 and 508, first and second GUIs can be opened.

In other words, users who use the common GUI on which the first and second GUIs are displayed alternately can use the system without being conscious of the fact that the GUIs that are created by different controllers are switched therebetween.

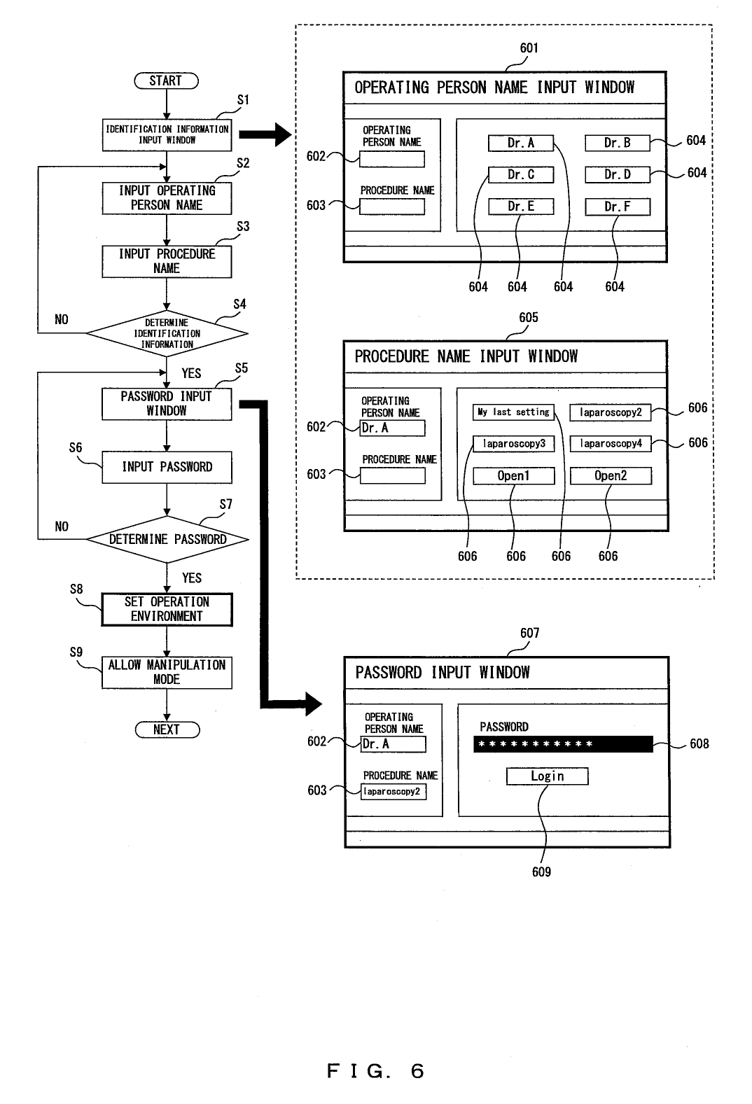

By referring to FIG. 6, log-in to the medical support control system for controlling the above described MC 114 and the NMC 202 is explained.

In step S1, an identification information input window for receiving identification information is displayed on the TP 221. Identification information input windows 601 and 605 have an operating-person-name input box 602 and a procedure-name input box 603. The identification information includes at least an operating person and a procedure name.

In step S2, an operating person is input. On the identification information input window 601 (operating-person-name input window), the operating person name is input directly into the operating-person-name input box 602 or the operating person name is selected from among the registered operating person names. In this example, operating-person-name selection switch buttons 604 (Dr. A through Dr. F) are prepared as a list of the operating persons, and the operating person is selected from among the operating-person-name selection switch buttons 604.

In step S3, a procedure name is input. On the identification information input window 605 (procedure-name input window), a procedure name is input directly into the procedure-name input box 603 or the procedure name is selected from among the registered procedure names. In this example, procedure name selection switch buttons 606 (“My last setting”, “laparoscopy2”, “laparoscopy4”, “laparoscopy3”, “Open1”, “Open2”, and the like) are prepared as the procedure names, and one of them is selected.

In step S4, it is determined whether or not the identification information has been input correctly. For example, it is determined whether or not the input operating person name or the input procedure name involves an error. When an error is involved, the process proceeds to step S2. When the identification information is correct, the process proceeds to step S5.

In step S5, a password input window 607 is displayed for accepting passwords. The password input window 607 has the operating-person-name input box 602, the procedure-name input box 603, a password input box 608, and a log-in button 609.

In step S6, a password is input. One password is prepared for each piece of identification information input in the above step.

In step S7, it is determined whether or not the input password is correct. It is determined whether or not the password corresponding to the identification information has been input. When the corresponding password has been input, the process proceeds to step S8, and the operation setting is performed. When the correct password has not been input, the process proceeds to step S5, and a password is again input.

In step S8, operation environment setting (that will be described later) is performed.

In step S9, a manipulation mode starts. The “manipulation mode” is a mode in which medical devices enter into an operation state.

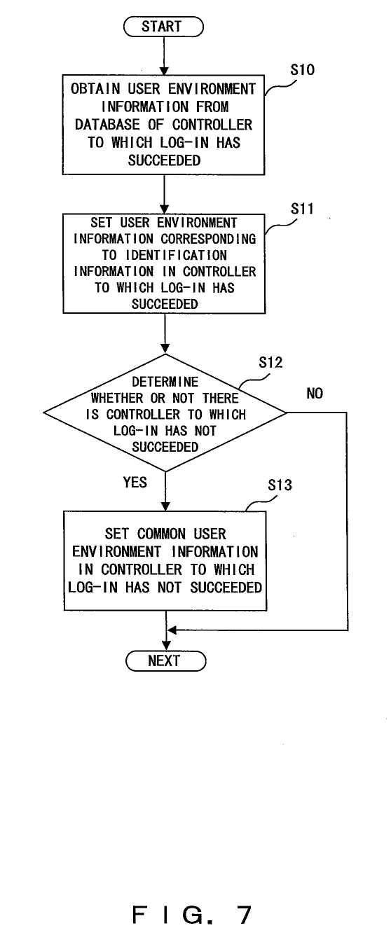

FIG. 7 is a flowchart for setting the operation environment.

In step S10, user environment information is obtained from the first or second controller to which log-in has succeeded. For example, when the log-in to the MC 114 and the NMC 202 has been successful, the user environment information is obtained respectively from the MC 114 and the NMC 202.

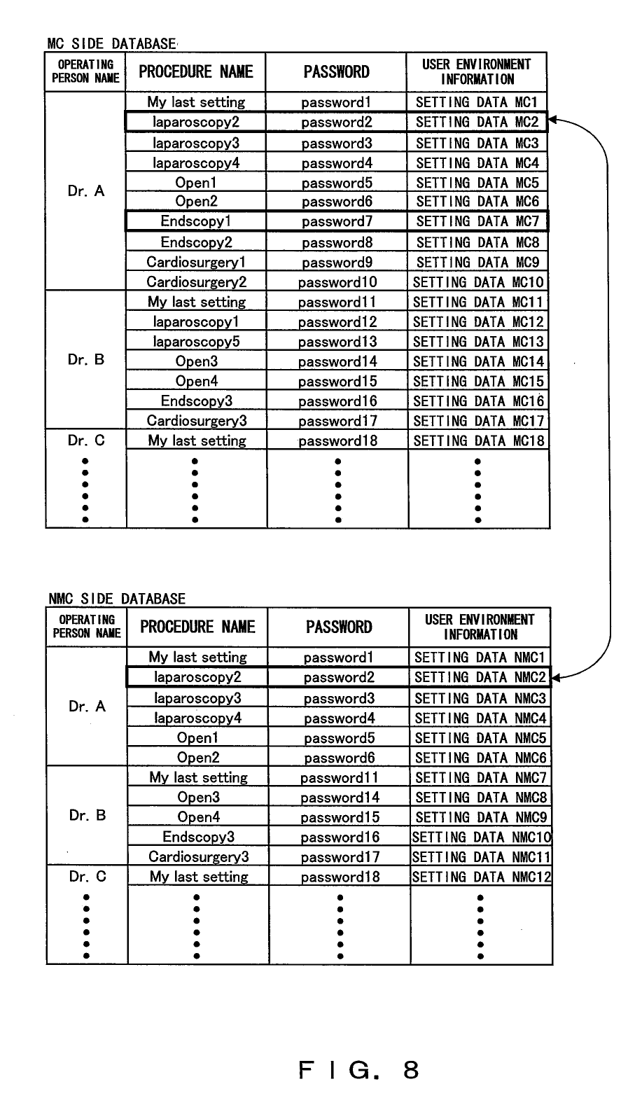

For example, user environment information corresponding to the identification information is obtained by using an MC-side database provided in the MC 114 and an NMC-side database provided in the NMC 202, as shown in FIG. 8. When the operating person is “Dr. A”, the procedure name is “laparoscopy2”, and the password is “password2”, “setting data MC2” and “setting data NMC2” are obtained (arrow). The MC-side database is stored in a storage unit in the MC 114, and the NMC-side database is stored in the storage unit 306 or the like.

Also, when there is no identification information that is included only in the MC-side database shown in FIG. 8 in the case when log-in is only successful to one of the controllers, the user environment information corresponding in the MC-side database is obtained. The operation environment in which the operating person is “Dr. A”, the procedure name is “endscopy1”, and the password is “password7” is selected and only “setting data MC7” is obtained.

Also, there is a case in which identification information that is included only in the NMC-side database is selected.

In step S11, the user environment information corresponding to the identification information is set in the controller to which log-in has succeeded. Different pieces of user environment information are set in the MC 114 and the NMC 202.

For example, when the operating person is “Dr. A”, the procedure name is “laparoscopy2”, and the password is “password2”, settings that are appropriate to the medical devices required for performing the laparoscopy examination on the MC 114 side are set in accordance with the contents of “setting data MC2”. Also, settings that are appropriate to the non-medical devices required for performing the laparoscopy examination on the NMC 202 are performed in accordance with the contents of the “setting data NMC2”.

In step S12, it is determined whether or not there is a controller to which log-in has not succeeded, and when there is, the process proceeds to step S13. For example, a case in which log-in was only successful to the MC 114 side or a case in which log-in was only successful to the NMC 202 side is detected.

In step S13, common user environment information is set in a controller to which log-in has not succeeded. The common user environment information is, for example, the initial values of parameters for medical devices and non-medical devices. It is also possible to set appropriate parameters for each medical device or non-medical device in advance, and to use such parameters as the common user environment information.

As described above, it is possible to provide a medical support control system for controlling medical devices and non-medical devices.

Conventionally, when it is desired to control a plurality of controllers in a system, log-in to each controller has been required. However, in the above configuration, by only logging in to one controller, it is possible to log in to the other controllers, which simplifies operations.

Also, if the respective controllers have the same identification information at the time of log-in, the operation environments for the controllers can be set by reading user environment information stored in each controller by using the identification information.

Even when there is a controller that cannot be logged into, the controller that cannot be logged into is logged into by using a general environment (common user environment information), and thereby operations are simplified.

The scope of the present invention is not limited to any of the above embodiments, and various alterations and modifications are allowed without departing from the spirit of the present invention.

What is claimed is:

1. A medical support control system, comprising:
a first controller connected to at least one device;
a second controller connected to at least one device; and
a manipulation display device shared by the first and second controllers, wherein:
the manipulation display device is caused to alternately display a first graphical user interface created by the first controller and second graphical user interface created by the second controller.

2. The medical support control system according to claim 1, wherein:
the first controller has first identification information and user environment information corresponding to the first identification information;
the second controller has second identification information and user environment information corresponding to the second identification information; and
when log-in to at least one of the first and second controllers has succeeded, an operation environment for the controller to which the log-in has succeeded is set in accordance with the user environment information.

3. The medical support control system according to claim 2, wherein:
an operation environment is set for controllers other than the controller to which the log-in has succeeded, in accordance with user environment information common to all users.

4. The medical support control system according to claim 1, wherein:
the identification information includes at least an operating person name and a procedure name; and
the user environment information is operation environment information of the controller to which the log-in has succeeded, used for setting an operation environment appropriate for a procedure performed by an operating person identified by the operating person name and the procedure name.
